(19) United States
(12) Patent Application Publication
(10) Pub. No.: US 2018/0362889 A1
(43) Pub. Date: Dec. 20, 2018

(54) AUTOMATIC DISHWASHING CLEANING COMPOSITION

(71) Applicant: The Procter & Gamble Company, Cincinnati, OH (US)

(72) Inventors: Rachel Elizabeth MARTIN, Newcastle upon Tyne (GB); Karen Margaret PRESTON, Newcastle upon Tyne (GB); Philip Frank SOUTER, Northumberland (GB)

(21) Appl. No.: 16/001,960

(22) Filed: Jun. 7, 2018

(30) Foreign Application Priority Data
Jun. 19, 2017 (EP) 17176686.8

(51) Int. Cl. C11D 3/33; C11D 3/37; C11D 3/386

(52) U.S. Cl. CPC C11D 3/33; C11D 3/386; C11D 3/378

(57) ABSTRACT

The present invention relates to a phosphate-free automatic dishwashing cleaning composition including an alkaline-metal carbonate and a builder system consisting of: i) a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof carboxy methyl inulin, its salts and derivatives thereof; and ii) an itaconic/sulfonic polymer; wherein the weight ratio of the carbonate to the builder system is at least 1.5:1.

### TECHNICAL FIELD

The present invention is in the field of cleaning. It relates to a cleaning product, in particular, it relates to a phosphate-free automatic dishwashing cleaning composition comprising an alkaline-metal carbonate and a primary builder in a high weight ratio. The composition provides good cleaning and surprisingly good finishing and presents a good environmental profile.

### BACKGROUND OF THE INVENTION

Automatic dishwashing detergents have been in the market for nearly a century now. Environmental regulations in terms of cleaning ingredients and energy requirements have changed over time. Automatic dishwashing detergents are continuously improving but still the detergents available do not seem to be effective under all conditions. Failures on the washed items are still found.

The design of an automatic dishwashing detergent is not straight forward. Users expect good cleaning and at the same time good finishing (lack of filming and spotting, and shine) of the washed items. Some cleaning actives such as alkaline metal carbonates are very good in terms of soil removal but they are believed to have a negative effect on filming, spotting and/or shine and/or they can damage the washed surfaces.

Chelation is crucial in automatic dishwashing. Chelation is the process by which calcium and other heavy metals are sequestered. In automatic dishwashing calcium and other heavy metals can be found as part of the hardness of the water or as part of the soils found in the dishwashing load. Builders play an important role in chelation in automatic dishwashing. Many different variables affect builder performance in automatic dishwashing. The binding calcium capacity of the builder is one of the variables that affect the builder performance but it is not the only one. The binding calcium capacity of a builder depends on several factors such as temperature, pH, ionic strength, etc. How the calcium binding capacity change with these factors seems to be different for each builder. The solubility and suspension capacities of the builder also need to be considered, as well as the size, stearic configuration, electrical charge, etc.

The different physical and chemical properties of a builder do not always contribute to cleaning in the same direction. For example, some builders have good binding constants but they do not have good suspension properties or they do not have the right size, stearic configuration, charge, etc.

Another consideration during the design of an automatic dishwashing detergent is the interaction protease/builder. Proteases are usually part of automatic dishwashing cleaning compositions. Calcium forms part of the proteases backbone. Strong chelants seem to negatively impact on the performance of proteases because the chelant would sequester the calcium from the backbone thereby denaturalizing the protease. This effect seems to be more acute when the wash liquor is overbuild, for example in the case or soft water or not very heavily soiled loads.

All in all, it is not straight forward to design a well performing automatic dishwashing detergent, especially if environmental concerns are taken into account.

### SUMMARY OF THE INVENTION

According to the first aspect of the invention, there is provided a phosphate-free automatic dishwashing cleaning composition. By “phosphate-free” is herein understood that the composition comprises less than 1%, preferably less than 0.1% by weight of the composition of phosphate. The composition comprises an alkaline-metal carbonate and at least 10%, preferably from 15% to 40% by weight of the composition of a builder system consisting of:
i) a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof carboxy methyl inulin, its salts and derivatives thereof; and
ii) an itaconic/sulfonic polymer
   wherein the weight ratio of the carbonate to the builder system is at least 1.5:1, preferably at least 1.8:1, more preferably at least 2:1.

The composition provides good cleaning and, in spite of the high level of carbonate, it provides good finishing, including lack of filming and spotting and provides good shine, in particular, on glass. It can also provide good care specially by avoiding the formation of a coloured film on stainless steel items. The composition is environmentally friendly due to the biodegradability of the builders. The composition of the invention can comprise other builders in addition to the builders of the builder system. For the purpose of this invention, additional builders will not be considered part of “the builder system”.

By “itaconic/sulfonic polymer” is herein meant a polymer comprising monomer units derived from itaconic acid and/or its salts and monomer units derived from sulfonic acid and/or its salts. The “itaconic/sulfonic polymer” is sometimes herein referred to as “the polymer” of the invention. Preferably, the polymer is free of tri-substituted vinyl monomer impurities, such as citraconic acid and/or mesaconic acid isomers. This can provide improved chelating capability.

The builder system preferably comprises more than about 40%, preferably more than about 45%, more preferably more than about 50% and specially from about 60% to about 80% by weight of the builder system of the complexing agent. Compositions comprising builder systems comprising high level of complexing agents provide very good cleaning and finishing. Preferred for use herein are salts of methyl glycine diacetic acid, in particular the sodium salt is preferred for use herein.

In preferred compositions, the builder system comprises from about 50% to about 80% by weight thereof of the complexing agent and from about 20% to 50% of the itaconic/sulfonic polymer.

Preferred polymers for use herein comprise monomer units derived from styrenesulfonic acid and/or salts thereof. Preferably, the polymer comprises from at least 5% to 20% by weight of the polymer of monomers comprising monomer units derived from sulfonic groups. Preferably the polymer has a weight average molecular weight of from about 800 g/mole to 10,000 g/mole.

Preferred polymers for use herein comprise monomer units derived from 2-acrylamido-2-methylpropane-sulfonic acid and/or salts thereof. Preferably, the polymer comprises from 15% to 40% by weight thereof of monomers units derived from sulfonic groups.

The composition preferably comprises a protease. Improved removal of burnt sugary soils is obtained when the composition of the invention comprise a protease as compared to a composition free of the polymer.

The composition comprises a high level of alkaline-metal carbonate in relation to the level of the builder system. High levels of alkaline-metal carbonates have been found to be very effective in automatic dishwashing. A drawback associated with such high carbonate levels, however, is that calcium ions present in the washing water readily form precipitates with the carbonate that can give rise to filming and spotting. Contrary to what it is to be expected, it has been surprisingly found during the course of this work that that compositions in which the weight ratio of the alkaline-metal carbonate to the builder system is at least 1:5.1, preferably from at least 1.8:1 to about 6:1 are very good in terms of finishing.

### DETAILED DESCRIPTION OF THE INVENTION

The present invention encompasses an automatic dishwashing cleaning composition comprising an alkaline-metal carbonate and a builder system in a high weight ratio. The composition provides very good cleaning and finishing, i.e, reduced filming, spotting and improved shine.

### The Alkaline Metal Carbonate

The composition of the invention comprises an alkaline-metal carbonate, preferably in a level of at least 30% by weight of the composition, more preferably in a level of from 35% to 60% by weight of the composition. Sodium carbonate is preferred for use herein.

### The Builder System

The cleaning composition of the invention preferably comprises at least 10% by weight of the composition of builder system, more preferably from 15% to 40% by weight of the composition of the builder system. The builder system consists of:
i) a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof carboxy methyl inulin, its salts and derivatives thereof; and
ii) an itaconic/sulfonic polymer;

### The Complexing Agent

A “complexing agent” is a compound capable of binding polyvalent ions such as calcium, magnesium, lead, copper, zinc, cadmium, mercury, manganese, iron, aluminium and other cationic polyvalent ions to form a water-soluble complex. The complexing agent has a logarithmic stability constant ([log K]) for Ca2+ of at least 5, preferably at least 6. The stability constant, log K, is measured in a solution of ionic strength of 0.1, at a temperature of 25° C.

The complexing agent is selected from the group consisting of methyl-glycine-diacetic acid (MGDA), its salts and derivatives thereof, glutamic-N,N-diacetic acid (GLDA), its salts and derivatives thereof, iminodisuccinic acid (IDS), its salts and derivatives thereof, carboxy methyl inulin, its salts and derivatives thereof and mixtures thereof. Especially preferred complexing agent for use herein is selected from the group consisting of MGDA and salts thereof, especially preferred for use herein is the three sodium salt of MGDA. Preferably, the complexing agent is the three sodium salt of MGDA and the polymer comprises styrenesulfonic acid and/or salts thereof.

### Itaconic/Sulfonic Polymer

Preferably, the builder system comprises less than 50% by weight of the system of the polymer, more preferably from 15% to 45% by weight of the system of the polymer.

The polymer comprises monomer units derived from itaconic acid and monomer units derived from sulfonic acid. Preferably, the polymer is essentially free of tri-substituted vinyl monomer impurities.

Preferably, the polymer comprises a group selected from 2-acrylamido-2-methylpropane-sulfonic acid, allylsulfonic acid, allyloxybenzenesulfonic acid, 2-hydroxy-3-(2-propenyloxy)propanesulfonic acid, 2-methyl-2-propene-1-sulfonic acid, styrene sulfonic acid, vinylsulfonic acid and alkali metal and ammonium salts thereof.

Preferred polymers comprise styrene sulfonic acid, its salts or mixtures thereof. Even more preferably the polymer comprises from 5% to 20% by weight of the polymer of monomers comprising styrene sulfonic acid, its salts or mixtures thereof.

Preferably, the polymer is essentially free of tri-substituted vinyl monomer impurities. Preferably the polymer has a weight average molecular weight of from about 500 g/mole to about 10,000 g/mole, preferably from about 800 g/mole to about 5,000 g/mole. Preferably the polymer has a number average molecular weight of from about 500 g/mole to about 10,000 g/mole, preferably from about 800 g/mole to about 5,000 g/mole. Preferably the polymer has a polydispersity of about 2.0.

The polymer can be manufactured following the method of polymerization described in WO 2011/113069 A1. Especially preferred polymer for use herein, especially in combination with methyl glycine diacetic acid is Itaconix® provided by Itaconix.

Other preferred polymers comprise 2-acrylamido-2-methylpropane-sulfonic acid, its salts or mixtures thereof. Even more preferably the polymer comprises from 15% to 40% by weight of the polymer of monomers comprising 2-acrylamido-2-methylpropane-sulfonic acid, its salts or mixtures thereof. Suitable polymers are described in WO2014/143773 A1 and WO2015/138872 A1 and supplied by Lubrizol.

### Automatic Dishwashing Cleaning Composition

The automatic dishwashing cleaning composition can be in any physical form. It can be a loose powder, a gel or presented in unit dose form. Preferably it is in unit dose form, unit dose forms include pressed tablets and water-soluble packs. The automatic dishwashing cleaning composition of the invention is preferably presented in unit-dose form and it can be in any physical form including solid, liquid and gel form. The composition of the invention is very well suited to be presented in the form of a multi-compartment pack, more in particular a multi-compartment pack comprising compartments with compositions in different physical forms, for example a compartment comprising a composition in solid form and another compartment comprising a composition in liquid form. The composition is preferably enveloped by a water-soluble film such as polyvinyl alcohol. Especially preferred are compositions in unit dose form wrapped in a polyvinyl alcohol film having a thickness of less than 100 μm. The detergent composition of the invention weighs from about 8 to about 25 grams, preferably from about 10 to about 20 grams. This weight range fits comfortably in a dishwasher dispenser. Even though this range amounts to a low amount of detergent, the detergent has been formulated in a way that provides all the benefits mentioned herein above.

### Bleach

The composition of the invention preferably comprises from about 1 to about 20%, more preferably from about 5 to about 18%, even more preferably from about 8 to about 15% of bleach by weight of the composition.

Inorganic and organic bleaches are suitable for use herein. Inorganic bleaches include perhydrate salts such as perborate, percarbonate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially dodecanediperoxoic acid, tetradecanediperoxoic acid, and hexadecanediperoxoic acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition of the invention comprises from 0.01 to 5, preferably from 0.2 to 2% by weight of the composition of bleach activator, preferably TAED.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt(III) and related complexes.

Preferably the composition of the invention comprises from 0.001 to 0.5, more preferably from 0.002 to 0.05% of bleach catalyst by weight of the composition. Preferably the bleach catalyst is a manganese bleach catalyst.

### Additional Builder

The composition of the invention can comprise builders in addition to the primary builder. Suitable additional builders include silicate.

### Other Polymers

The composition of the invention can also comprise polymers free of itaconic monomers. Other polymers can be used in any suitable amount from about 0.1 to about 10%, preferably from 0.2 to about 15%, more preferably from 0.3 to 8% by weight of the composition

Other polymers include sulfonated derivatives of polycarboxylic acids and may comprise two, three, four or more different monomer units. The preferred copolymers contain:

At least one structural unit derived from a carboxylic acid monomer having the general formula (III):

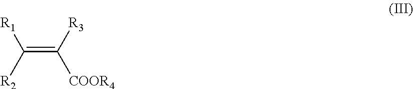

wherein R₁ to R₃ are independently selected from hydrogen, methyl, linear or branched saturated alkyl groups having from 2 to 12 carbon atoms, linear or branched mono or polyunsaturated alkenyl groups having from 2 to 12 carbon atoms, alkyl or alkenyl groups as aforementioned substituted with —NH2 or —OH, or —COOH, or COOR₄, where R₄ is selected from hydrogen, alkali metal, or a linear or branched, saturated or unsaturated alkyl or alkenyl group with 2 to 12 carbons;

Preferred carboxylic acid monomers include one or more of the following: acrylic acid, maleic acid, maleic anhydride, citraconic acid, 2-phenylacrylic acid, cinnamic acid, crotonic acid, fumaric acid, methacrylic acid, 2-ethylacrylic acid, methylenemalonic acid, or sorbic acid. Acrylic and methacrylic acids being more preferred.

Optionally, one or more structural units derived from at least one nonionic monomer having the general formula (IV):

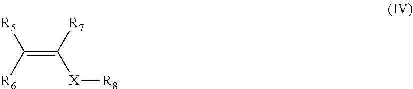

wherein R₅ to R₇ are independently selected from hydrogen, methyl, phenyl or hydroxyalkyl groups containing 1 to 6 carbon atoms, and can be part of a cyclic structure, X is an optionally present spacer group which is selected from —CH₂—, —COO—, —CONH— or —CONR₈—, and R₈ is selected from linear or branched, saturated alkyl radicals having 1 to 22 carbon atoms or unsaturated, preferably aromatic, radicals having from 6 to 22 carbon atoms.

Preferred non-ionic monomers include one or more of the following: butene, isobutene, pentene, 2-methylpent-1-ene, 3-methylpent-1-ene, 2,4,4-trimethylpent-1-ene, 2,4,4-trimethylpent-2-ene, cyclopentene, methylcyclopentene, 2-methyl-3-methyl-cyclopentene, hexene, 2,3-dimethylhex-1-ene, 2,4-dimethylhex-1-ene, 2,5-dimethylhex-1-ene, 3,5-dimethylhex-1-ene, 4,4-dimethylhex-1-ene, cyclohexene, methylcyclohexene, cycloheptene, alpha olefins having 10 or more carbon atoms such as, dec-1-ene, dodec-1-ene, hexadec-1-ene, octadec-1-ene and docos-1-ene, preferred aromatic monomers are styrene, alpha methylstyrene, 3-methylstyrene, 4-dodecylstyrene, 2-ethyl-4-bezylstyrene, 4-cyclohexylstyrene, 4-propylstyrol, 1-vinylnaphtalene, 2-vinylnaphtalene; preferred carboxylic ester monomers are methyl (meth)acrylate, ethyl (meth)acrylate, propyl (meth)acrylate, t-butyl (meth)acrylate, pentyl (meth)acrylate, hexyl (meth)acrylate, 2-ethylhexyl (meth)acrylate, octyl (meth)acrylate, lauryl (meth)acrylate, stearyl (meth)acrylate and behenyl (meth)acrylate; preferred amides are N-methyl acrylamide, N-ethyl acrylamide, N-t-butyl acrylamide, N-2-ethylhexyl acrylamide, N-octyl acrylamide, N-lauryl acrylamide, N-stearyl acrylamide, N-behenyl acrylamide.

And at least one structural unit derived from at least one sulfonic acid monomer having the general formula (V) and (VI):

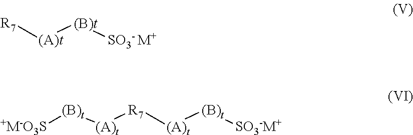

wherein R₇ is a group comprising at least one sp2 bond, A is O, N, P, S, an amido or ester linkage, B is a mono- or polycyclic aromatic group or an aliphatic group, each t is independently 0 or 1, and M+ is a cation. In one aspect, R₇ is a C2 to C6 alkene. In another aspect, R7 is ethene, butene or propene.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

Other polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol, preferably from about 5,000 to about 45,000 g/mol. The dispersant polymer may be a low molecular weight homopolymer of polyacrylate, with an average molecular weight of from 1,000 to 20,000, particularly from 2,000 to 10,000, and particularly preferably from 3,000 to 5,000.

The other polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000 and more preferably from 20,000 to 50,000 and in particular 30,000 to 40,000 g/mol. and a ratio of (meth)acrylate to maleate or fumarate segments of from 30:1 to 1:2.

The other polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such dispersant polymer may have a molecular weight of from 4,000 to 20,000 and an acrylamide content of from 0% to 15%, by weight of the polymer.

Alternatively, the other polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

The composition of the invention can be preferably free of other polymers.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs. The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

### Enzymes

In describing enzyme variants herein, the following nomenclature is used for ease of reference: Original amino acid(s):position(s): substituted amino acid(s). Standard enzyme IUPAC 1-letter codes for amino acids are used.

### Proteases

The composition of the invention is beneficial in terms of removal of proteinaceous soils.

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: S9R, A15T, V68A, N87S, S99A, S99D, S99SD, S99SE, S101G, S101M, S103A, V104N/I, G118V, G118R, S128L, P129Q, S130A, Y167A, R170S, A194P, V205I, N218D and/or M222S, Q245R.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

(i) S9R+A15T+V68A+N218D+Q245R;

(ii) G118V+S128L+P129Q+S130A

(iii) N76D+N87R+G118R+S128L+P129Q+S130A+S188D+N248R

(iv) N76D+N87R+G118R+S128L+P129Q+S130A+S188D+V244R

(v) N76D+N87R+G118R+S128L+P129Q+S130A

(vi) V68A+N87S+S101G+V104N

(vii) S101M+G118V+S128L+P129Q+S130A

Suitable commercially available protease enzymes include those sold under the trade names Savinase®, Polarzyme®, Kannase®, Ovozyme®, Everlase®, Blaze®, Blaze Evity® and Esperase® by Novozymes A/S (Denmark), those sold under the tradename Properase®, Purafect®, Purafect Prime®, Purafect Ox®, FN3®, FN4®, Excellase®, Excellenz P®, Ultimase®, Eraser® and Purafect OXP® by Genencor International, those sold under the tradename Opticlean® and Optimase® by Solvay Enzymes, those available from Henkel/Kemira, namely BLAP.

Preferred levels of protease in the composition of the invention include from about 0.2 to about 2 mg of active protease per grams of the composition.

Amylases The composition of the invention can comprise amylases. A preferred alkaline amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 SEQ ID No. 3: 9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) Variants exhibiting at least 95% identity with the wild-type enzyme from Bacillus sp.707 (SEQ ID NO:7 in U.S. Pat. No. 6,093,562), especially those comprising one or more of the following mutations M202, M208, 5255, R172, and/or M261. Preferably said amylase comprises one of M202L or M202T mutations.
(c) Variants exhibiting at least 95% identity with SEQ ID NO:1 of WO2016091688, especially those comprising one or more, preferably two or more or even three or more of the following mutations H183*, G184*, I405L, A421H, A422P and A428T.

Suitable commercially available alpha-amylases include DURAMYL®, LIQUEZYME®, TERMAMYL®, TERMAMYL ULTRA®, NATALASE®, EVEREST®, SUPRAMYL®, STAINZYME®, STAINZYME PLUS®, AMPLIFY®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE®, EXCELLENZ™ S series, including EXCELLENZ™ S 1000 and EXCELLENZ™ S 2000 and PURASTAR OXAM® (DuPont Industrial Biosciences, Palo Alto, Calif.) and KAM® (Kao, 14-10 Nihonbashi Kayabacho, 1-chome, Chuo-ku Tokyo 103-8210, Japan). Amylases especially preferred for use herein include AMPLIFY®, STAINZYME®, STAINZYME PLUS®, EXCELLENZ™ S 1000, EXCELLENZ™ 52000 and mixtures thereof.

Preferably, the composition of the invention comprises at least 0.005 mg, preferably from about 0.0025 to about 0.025, more preferably from about 0.05 to about 0.3, especially from about 0.01 to about 0.25 mg of active amylase.

Preferably, the protease and/or amylase of the composition of the invention are in the form of granulates, the granulates comprise more than 29% of sodium sulfate by weight of the granulate and/or the sodium sulfate and the active enzyme (protease and/or amylase) are in a weight ratio of between 3:1 and 100:1 or preferably between 4:1 and 30:1 or more preferably between 5:1 and 20:1.

### Crystal Growth Inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition of the invention comprises from 0.01 to 5%, more preferably from 0.05 to 3% and especially from 0.5 to 2% of a crystal growth inhibitor by weight of the product, preferably HEDP.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and especially from 0.3 to 3% by weight of the product of a metal care agent, preferably the metal care agent is benzo triazole (BTA).

### Glass Care Agents

Glass care agents protect the appearance of glass items during the dishwashing process. Preferably the composition of the invention comprises from 0.1 to 5%, more preferably from 0.2 to 4% and specially from 0.3 to 3% by weight of the composition of a metal care agent, preferably the glass care agent is a zinc containing material, specially hydrozincite.

The automatic dishwashing composition of the invention preferably has a pH as measured in 1% weight/volume aqueous solution in distilled water at 25° C. of greater than 10.5, more preferably from about 10.6 to about 12, more preferably from about 10.7 to less than about 11.8 and especially from about 10.7 to about 11.5.

The automatic dishwashing composition of the invention preferably has a reserve alkalinity of from about 10 to about 20, more preferably from about 12 to about 18 at a pH of 9.5 as measured in NaOH with 100 grams of product at 20° C.

A preferred automatic dishwashing composition of the invention comprises:
i) from 30% to 50% by weight of the composition of the builder system comprising at least 40% by weight thereof of methyl glycine diacetic acid and/or a salt thereof;
ii) from 40 to 60% by weight of the composition of sodium carbonate;
iii) from 2 to 20% by weight of the composition of bleach, preferably sodium percarbonate;
iv) a protease;
v) optionally but preferably from 2 to 10% by weight of the composition of a non-ionic surfactant;
vi) optionally but preferably a bleach catalyst, more preferably a manganese bleach catalyst;
vii) other optional ingredients include: a crystal growth inhibitor, preferably HEDP, and glass care agents.
   A preferred automatic dishwashing composition of the invention comprises:
i) from 5% to 50% by weight of the composition of an itaconix/sulfonic polymer comprising from 5% to 20% by weight thereof of monomer units derived from styrenesulfonic acid and/or salts thereof;
ii) from 20 to 60% by weight of the composition of sodium carbonate;
iii) from 2 to 20% by weight of the composition of bleach, preferably sodium percarbonate; a bleach activator, more preferably TAED;
iv) a protease;
v) optionally but preferably from 2 to 10% by weight of the composition of a non-ionic surfactant;
vi) optionally but preferably a bleach catalyst, more preferably a manganese bleach catalyst;
vii) other optional ingredients include: a crystal growth inhibitor, preferably HEDP, and glass care agents.
   A preferred automatic dishwashing composition of the invention comprises:
i) from 35% to 50% by weight of the composition of a builder system comprising a mixture of an itaconix/sulfonic polymer comprising from 15% to 40% by weight thereof of monomers comprising 2-acrylamido-2-methylpropane-sulfonic acid and methyl glycine diacetic acid and/or a salt thereof;
ii) from 40 to 55% by weight of the composition of sodium carbonate;
iii) from 2 to 20% by weight of the composition of bleach, preferably sodium percarbonate;
iv) preferably a bleach activator, more preferably TAED;
v) enzymes, preferably amylases and proteases;
vi) optionally but preferably from 2 to 10% by weight of the composition of a non-ionic surfactant;
vii) optionally but preferably a bleach catalyst, more preferably a manganese bleach catalyst;

other optional ingredients include: a crystal growth inhibitor, preferably HEDP, and glass care agents.

### EXAMPLES

Three automatic dishwashing formulas were made comprising the ingredients detailed herein.
1. Composition 1, having carbonate and a primary builder (MGDA) in a weight ratio of less than 1.1:1, outside the scope of the invention;
2. Composition 2, having carbonate and a primary builder (mixture of MGDA and itaconic/sulfonic polymer) in a weight ratio of less than 1.1:1, outside the scope of the invention; and
3. Composition 3, having carbonate and a primary builder (mixture of MGDA and itaconic/sulfonic polymer) in a weight ratio of more than 1.1:1, in accordance with the invention.

| Ingredients | Composition 1 | | Composition 2 | | Composition 3 | |
|---|---|---|---|---|---|---|
| (active grams) | Comparative | | Comparative | | Invention | |
| Solid | | | | | | |
| MGDA | 5.6 | g | 3 | g | 3 | g |
| Itaconic/sulfonic | — | | 5 | g | 0.5 | g |
| polymer | | | | | | |
| Other sulfonated | 0.4 | g | 0.4 | g | 0.4 | g |
| polymer | | | | | | |
| Sodium carbonate | 2.9 | g | 1 | g | 10 | g |
| Amylase | 8 | mg | 8 | mg | 8 | mg |
| Protease | 38 | mg | 38 | mg | 38 | mg |
| Sodium percarbonate | 3 | g | 3 | g | 3 | g |
| Bleach catalyst and | 4 | mg | 4 | mg | 4 | mg |
| bleach activator | | | | | | |
| HEDP | 0.1 | g | 0.1 | g | 0.1 | g |
| Miscellaneous | 0.2 | g | 0.2 | g | 0.2 | g |
| Liquid | | | | | | |
| Plurafac SLF-180 | 0.8 | g | 0.8 | g | 0.8 | g |
| Lutensol TO7 | 0.9 | g | 0.9 | g | 0.9 | g |
| Miscellaneous | 0.5 | g | 0.5 | g | 0.5 | g |

| | | | |
|---|---|---|---|
| pH at 1% in dH₂O | 10.79 | 10.01 | 10.81 |

MGDA Tri-sodium salt of methyl glycine diacetic acid
Other sulfonated polymer Acusol 588 supplied by Dow
Bleach activator TAED (Tetraacetylethylenediamine)
Bleach catalyst Manganese bleach catalyst
HEDP 1-hydroxyethylidene 1,1-diphosphonic acid
Plurafac SLF-180 Nonionic surfactant supplied by BASF
Lutensol TO7 Nonionic surfactant supplied by BASF

### Inorganic Shine Test

The multi-cycle test was carried out using a Miele dishwasher, in a normal wash 65° C. setting. On each cycle 50 g of soil 1 were added into the dishwasher at the start of the wash. The water hardness was about 130 ppm cations (Ca²⁺, Mg²⁺).

The glasses were washed (30 cycles) with Compositions 1 and 2, outside the scope of the invention and with Composition 3, comprising an itaconic/sulfonic polymer according to the invention.

After running 30 consecutives cycles, the glasses were then photographed against a black background and the images were analyzed using computer aided software to measure percentage clarity. Clarity index (%) is a calculation of image intensity. The mean film gray level is a measurement of gray level in the range 0-255. The quoted clarity index (%) is the percentage of the way from 0-255. A clarity index of 100 would occur with a completely dark glass with a gray level of zero. A clarity index of 0 would occur with a completely white glass with a gray level of 255. A clarity difference of 2 is significant.

| Composition | Clarity Index at 30 Cycles (%) |
|---|---|
| 1 | 92.1 |
| 2 | 89.3 |
| 3 | 93.9 |

Composition 3, according to the invention, provides a better clarity index than comparative Composition 2.

### Test Method

Soil 1 is prepared with the following protocol:

| Ingredient | Weight | Tolerance |
|---|---|---|
| City water | 2500 g | ±1 g |
| Smash | 18 g | ±0.2 g |
| Milk full fat UHT | 179 g | ±0.5 g |
| Heinz Tomato Ketchup | 89 g | ±0.5 g |
| Coleman's English Mustard | 89 g | ±0.5 g |
| Bisto gravy | 89 g | ±0.5 g |
| Stork margarine | 357 g | ±1 g |
| Egg yolk | 179 g | ±1 g |
| Total | 3500 g | |

1. Measure the tap water into a pan and heat to ˜50° C.
2. Add all of the ingredients except margarine to the pan stirring well to avoid lumps.
3. Slowly add the margarine making sure it is broken up into small pieces first.
4. Heat to between 88-90° C., simmering. Then turn the heat to the lowest setting for a further 10 minutes.
5. Allow the mixture to cool to at least 35° C., if not 3500 g in total top up with City water.
6. Stir well then weigh out 50 g batches of this mixture into plastic pots and freeze.

### Cleaning Test

Compositions 1, 2 and 3 were also compared for their cleaning performance using a crème brûlee soil.

Five crème brûlee stained plates are placed in the bottom rack of a Miele GSL dishwasher and an additional 50 g of soil 2 are added at the beginning of the wash. The water hardness was about 130 ppm cations (Ca²⁺, Mg²⁺) and the R45 cycle was used. The test is repeated three more times using new plates each time. At the end the plates are evaluated using a visual grading scale with 0 being unclean and 10 being completely clean. The plates are graded by three different individuals and the results correlated using a statistics package.

| Composition | Crème Brûlee Visual Grade |
|---|---|
| 1 | 5.50 |
| 2 | 1.65 |
| 3 | 7.03 |

Composition 3, according to the invention, provides better crème brûlee removal than comparative Compositions 1 and 2.

### Test Method

Soil 2 is prepared with the following protocol:

| Ingredient | Weight | | Tolerance |
|---|---|---|---|
| Potato starch - Tipiak (Fecule) | 136 | g | ±0.5 g |
| Wheat flour - Rochambeau (Farine de ble) | 109.5 | | ±0.5 g |
| Vegetable oil | 108 | g | ±0.5 g |
| Margarine | 108 | g | ±0.5 g |
| Lard | 108 | g | ±0.5 g |
| Single cream | 219 | g | ±0.5 g |
| Baking spread | 108 | g | ±0.5 g |
| Large eggs | 219 | g | ±0.5 g |
| Whole milk | 219 | g | ±0.5 g |
| Ketchup - Heinz | 75 | g | ±0.5 g |
| Mustard - Amora, Moutarde de Dijon | 100 | g | ±0.5 g |
| Benzoic acid - ex Fluka or equivalent | 18.5 | g | ±0.2 g |
| Hard water | 918 | g | ±1 g |
| Total | 2446 | | |

1. Add water to the potato starch, heat in a pan until the gel formed is properly inflated. Leave the pan to cool at room temperature overnight.
2. Weigh out the appropriate amounts of each ingredient as detailed above.
3. Add the ketchup and mustard to a bowl and mix vigorously (Speed 6) until fully combined, 1 minute.
4. Melt margarine (1 min), lard (2 min) and baking spread (1 min) individually in a microwave (full power 750W) and allow to cool to room temperature (15 mins) then mix together. Speed 6
5. Add wheat flour and benzoic acid to a bowl and mix vigorously. Speed 6
6. Break 5-6 large eggs into a bowl and mix vigorously (1 min). Speed 6
7. Weigh out 219 g of the eggs into a bowl. Add 219 g vegetable oil to the eggs and stir using a hand blender (1 min)
8. Mix the cream and milk in a bowl (1 min)
9. Add all of the ingredients together into a large container and mix using Blixer Coupe 5VV (10 mins @ Speed 6)
10. Weigh out 50 g batches of this mixture into plastic pots and freeze.
   Crème brûlee stained plates are prepared with the following procedure:
1. Crème brûlee mixture (Debic crème brûlee) is heated to 60° C. while stirring.
2. Mixture is allowed to cool, stirring occasionally until the mixture is below 30° C.
3. The mixture is then painted onto dessert plates which are clean and free of grease and have previously been rinsed with an alkaline detergent. For each dish 3.5g+/−0.2 g is applied uniformly.
4. The mixture is allowed to dry onto the plates at room temperature for 2 hours.
5. The plates are placed into an oven, which has not been preheated, for 2 hours at 140° C.
6. After cooling the plates are ready to use.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A phosphate-free automatic dishwashing cleaning composition comprising an alkaline-metal carbonate and a builder system consisting of:
i) a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof carboxy methyl inulin, its salts and derivatives thereof; and
ii) an itaconic/sulfonic polymer;
wherein the weight ratio of the carbonate to the builder system is at least 1.5:1.

2. A composition according to claim 1 wherein the composition has a pH greater than 10.5 as measured in a 1% by weight aqueous solution at 25° C.

3. A composition according to claim 1 wherein the builder system comprises more than 40% by weight thereof of the complexing agent.

4. A composition according to claim 1 wherein the builder system comprises from about 50% to about 80% by weight thereof of the complexing agent and from about 20% to about 50% by weight thereof of the itaconic/sulfonic polymer.

5. A composition according to claim 1 wherein the complexing agent is a salt of methyl glycine diacetic acid.

6. A composition according to claim 1 wherein the polymer comprises monomer units derived from 2-acrylamido-2-methylpropane-sulfonic acid, allylsulfonic acid, allyloxybenzenesulfonic acid, 2-hydroxy-3-(2-propenyloxy) propanesulfonic acid, 2-methyl-2-propene-1-sulfonic acid, styrene sulfonic acid or vinylsulfonic acid; and alkali metal and ammonium salts thereof.

7. A composition according to claim 1 wherein the polymer comprises monomer units derived from styrenesulfonic acid and/or salts thereof.

8. A composition according to claim 1 wherein the polymer comprises from about 5% to about 20% by weight thereof of monomer units derived from sulfonic groups.

9. A composition according to claim 1 wherein the polymer comprises monomer units derived from 2-acrylamido-2-methylpropane-sulfonic acid.

10. A composition according to claim 1 wherein the polymer comprises from about 15% to about 40% by weight thereof of monomers derived from sulfonic groups.

11. A composition according to claim 1 wherein the polymer is essentially free of tri-substituted vinyl monomer impurities.

12. A composition according to claim 1 further comprising a protease.

13. A composition according to claim 1 further comprising bleach.

14. A composition according to claim 1 wherein the composition is free of silicate.

15. A composition according to claim 1 further comprising a crystal growth inhibitor.
